(19) United States
(12) Patent Application Publication
(10) Pub. No.: US 2004/0051781 A1
(43) Pub. Date: Mar. 18, 2004

(54) Color conversion filter, color conversion layer and color conversion light emitting device

(76) Inventors: Koji Kawaguchi, Kanagawa (JP); Makoto Kobayashi, Kanagawa (JP); Kenya Sakurai, Kanagawa (JP)

Correspondence Address: KANESAKA AND TAKEUCHI, 1423 Powhatan Street, Alexandria, VA, 22314, US

(21) Appl. No.: 10/620,616

(22) Filed: Jul. 17, 2003

(30) Foreign Application Priority Data
Jul. 19, 2002 (JP) 2002-211703

(51) Int. Cl. H04N 9/64

(52) U.S. Cl. 348/34; 348/33

(57) ABSTRACT

A color conversion layer includes a matrix resin, a fluorescence conversion dye and a dendrimer for converting a wavelength distribution of incident light and emitting a converted light. The fluorescence conversion dye and the dendrimer may be chemically bonded to each other via a covalent bond. Alternatively, the dendrimer may include the fluorescence conversion dye in a clathrate state.

### BACKGROUND OF THE INVENTION AND RELATED ART STATEMENT

The present invention relates to a color conversion filter with good environmental resistance and high productivity for displaying multiple colors with high definition. In particular, the invention relates to a color conversion filter used for a display in an image sensor, personal computer, word processor, television, facsimile device, audio system, video system, car navigation system, electronic calculator, telephone, personal digital assistant and industrial measuring instrument.

In recent years, the information technology has been rapidly advanced. A display device used in the information technology has been required to have a better aesthetic appearance, a lighter weight, a thinner thickness and higher performance. Furthermore, a great effort has been made to reduce power consumption and increase a response speed. In particular, many attempts have been made to develop a high-definition full-color display device.

As opposed to a liquid crystal display device, an organic electro-luminescence (hereinafter referred to as ‘organic EL’) device with an organic molecule thin-layered structure has been developed as a device having higher contrast, constant-voltage driving, wider angle visibility, and faster response. Tang et al. has reported that an organic EL showed a high luminance of 1000 cd/m² at an applied voltage of 10 V (Appl. Phys. Lett., 51, 913 (1987)). After the report by Tang et al., a great effort has been made to develop an organic EL device for a practical use. Attempts have also been made to develop similar devices composed of an organic polymer material.

Since the organic EL device provides a high current density at a low voltage, it is expected to provide higher emission luminance and efficiency as opposed to inorganic EL devices and LEDs. As a display device, the organic EL display device has characteristics such as (1) high luminance and high contrast, (2) low driving voltage and high emission efficiency, (3) high resolution, (4) wide angle visibility, (5) high response speed, (6) possibility of increasing definition and providing color displays, (7) reduced weight and thickness, and the like. Thus, the organic EL device is expected to have a better aesthetic appearance, a lighter weight, a thinner thickness and higher performance.

Tohoku Pioneer Corporation has already developed products including vehicle-mounted green monochrome organic EL displays since November 1997. In order to meet the society needs, it is desirable to develop improved organic EL displays that are stable for an extended period of time, respond quickly, and display multiple colors or full colors with high definition.

As a method of displaying multiple or full colors with the organic EL display, light-emitting materials emitting the three primary colors, i.e. Red (R), Green (G), and Blue (B), are formed separately in a matrix form. Japanese Patent Publications No. 57-167487, No. 58-147989, and No. 03-214593 have disclosed such an approach. In the method of displaying multiple or full colors with the organic EL display, it is necessary to arrange the three types of light-emitting materials (R, G, and B) in a matrix form with high precision, thereby making it technically difficult to produce such a device at a low cost. Further, the three types of light-emitting materials have different life times, thereby shifting a color of the display with time.

As another method, Japanese Patent Publications No. 01-315988, No. 02-273496, and No. 03-194895 have disclosed a method in which a color filter and a backlight emitting white light are used to display the three primary colors through the filter. However, it is difficult to obtain an organic light emitting device emitting bright white light for a long time, which is necessary for obtaining bright three colors R, G, and B.

Alternatively, Japanese Patent Publication No. 03-152897 has disclosed another method in which phosphors arranged on a plane absorb light from a light emitting device, so that the phosphors emit fluorescence in multiple colors. Such a method using a certain luminous device to allow the phosphors to emit fluorescence in multiple colors has been applied to CRTs, plasma displays, and the like.

Further, in recent years, a color conversion method has been proposed in which a filter is composed of a fluorescent material for absorbing light with a wavelength in a region of light emitted from an organic light emitting device, so that the fluorescent material emits fluorescence with a wavelength in a visible light region (Japanese Patent Publications No. 03-152897 and No. 05-258860). In this approach, an organic light emitting device that emits a color other than white can be used. Therefore, it is possible to use an organic light emitting device with higher brightness as a light source.

In a color conversion method using an organic light emitting device emitting blue light (Japanese Patent Publications No. 03-152897, No. 08-286033, and No. 09-208944), a frequency of the blue light is converted to that of green or red light. A color conversion filter containing a fluorescent material with such color conversion effect may be formed in a high-resolution pattern. Accordingly, it is possible to provide a full-color light emitting display even with weak energy light such as near-ultraviolet light or visible light.

It is important to provide a color conversion filter with high color conversion efficiency as well as a long-term stability including a color displaying function and color repeatability for practical use as a color display. There has been an active research work in various organizations for improving the color conversion efficiency. For example, as disclosed in Japanese Patent Publication No. 2000-103795, a method in which a rhodamine derivative with a bulky substitute group is used for improving the conversion efficiency to display the red color.

A major problem in improving the color conversion efficiency of a color conversion filter is that it is difficult to increase a content of fluorescence conversion dye. It is known that when the content of the fluorescent dye is increased, the conversion efficiency is drastically reduced due to so-called concentration quenching. Furthermore, in a high concentration state, it is known that the fluorescence conversion dye tends to be decomposed instead of going through a path in which the dye in an excited state emits fluorescence to return to the ground state. Therefore, when the fluorescence conversion dye is contained at a high concentration, even though the efficiency thereof is optimized at an initial stage, the color conversion efficiency is abruptly reduced while the dye is in service.

In view of the problems described above, it is an object of the present invention to provide a fluorescence conversion dye for a color conversion filter with high color conversion efficiency and no decomposition even at a high content of the dye.

It is another object of the present invention to provide a color conversion layer having a structure in which high color conversion efficiency of the fluorescence conversion dye is maintained, and decomposition of the dye is suppressed.

It is a further object of the invention to provide a fluorescence conversion dye for a color conversion filter with high efficiency even at a low content.

Further objects and advantages of the invention will be apparent from the following description of the invention.

### SUMMARY OF THE INVENTION

According to the present invention, a color conversion filter includes a transparent substrate and a color conversion layer formed on the transparent substrate. The color conversion layer includes a matrix resin, a fluorescence conversion dye and a dendrimer. The fluorescence conversion dye and the dendrimer may be chemically bonded to each other via a covalent bond. Alternatively, the dendrimer may include the fluorescence conversion dye in a clathrate state.

According to the invention, a color conversion layer includes a matrix resin, a fluorescence conversion dye and a dendrimer for converting a wavelength distribution of incident light and emitting the converted light. The fluorescence conversion dye and the dendrimer may be chemically bonded to each other via a covalent bond. Alternatively, the dendrimer may include the fluorescence conversion dye in a clathrate state.

According to the invention, a color conversion light emitting device includes a light emitting section and a color conversion section for converting a wavelength distribution of light emitted from the light emitting section. The color conversion section includes a matrix resin, a fluorescence conversion dye and a dendrimer. The fluorescence conversion dye and the dendrimer may be chemically bonded to each other via a covalent bond. Alternatively, the dendrimer may include the fluorescence conversion dye in a clathrate state.

### BRIEF DESCRIPTION OF THE DRAWINGS

FIG. 1 is a cross sectional view showing a color conversion filter according to the invention;

FIG. 2 is a cross sectional view showing a color conversion filter for a display according to the invention; and

FIG. 3 is a cross sectional view showing an organic multiple-color EL display with the color conversion filter according to the invention.

### DETAILED DESCRIPTION OF PREFERRED EMBODIMENTS

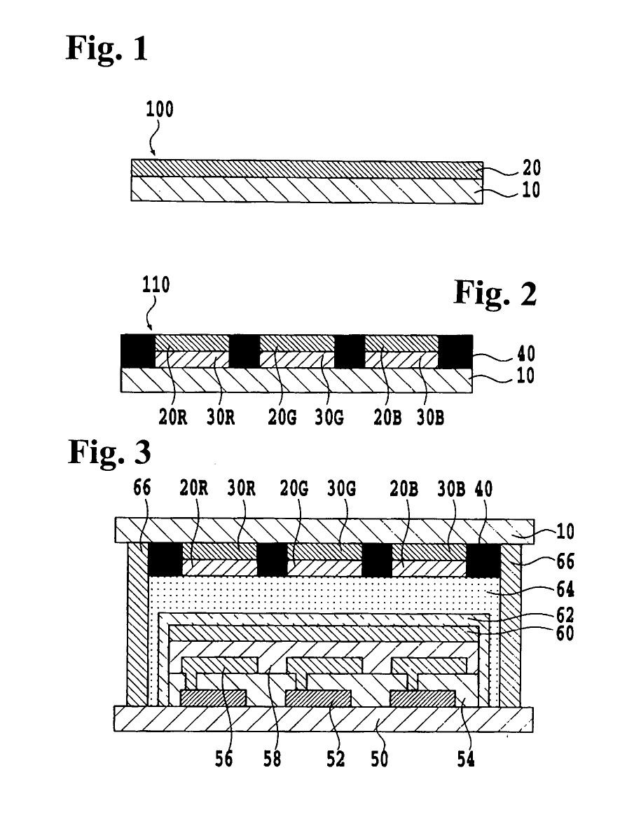

Hereunder, embodiments of the invention will be explained in detail with reference o the accompanying drawings. A substrate of a color conversion filter according to the invention is shown in FIG. 1. In FIG. 1, a color conversion layer 20 is formed on a transparent substrate 10. The transparent substrate 10 used for the color conversion filter according to the invention must be transparent to either light emitted from a light source or light converted by the color conversion layer 20. Moreover, the transparent substrate 10 needs to be resistant to conditions (solvent, temperature, etc.) under which the color conversion layer 20 and other layers (described later) according to other requirements are formed. Furthermore, it is preferable that the transparent substrate 10 is superior in dimensional stability. A preferable material for the transparent substrate 10 includes glass and such resins as polyethylene terephthalate and polymethyl methacrylate. In particular, borosilicate glass, blue plate glass, etc. are preferable.

The color conversion layer 20 according to the invention includes a matrix resin, a fluorescence conversion dye and a dendrimer. Each of the materials will be explained as follows. The fluorescence conversion dye according to the invention absorbs light ranging from a near ultraviolet region to a visible region emitted from a light source to convert a wavelength distribution to thereby emit visible light with a different wavelength as fluorescence. In particular, it is preferable that the dye absorbs light ranging from a blue region to a bluish green region. For example, a suitable fluorescence conversion dye includes a dye absorbing light ranging from the blue region to the bluish green region to emit fluorescence in a red region, a dye absorbing light ranging from the blue region to the bluish green region to emit fluorescence in a green region, or a dye absorbing light ranging from the near ultraviolet region to the visible region to emit the blue fluorescence.

In a case that a light source that emits light with a wavelength in the blue or bluish-green region is used, when the light is converted to light with a wavelength in the red region through a simple red filter, an intensity of the light is greatly reduced due to a small amount of the red light in the original light. In this case, it is possible to obtain high intensity light with a wavelength in the red region by using a fluorescence dye to convert the light from the organic light emitting device into the light with a wavelength in the red region.

In the case of obtaining blue color, an organic fluorescence dye may be used to convert the blue light with a shorter wavelength into desired blue light with a different wavelength. Alternatively, it is possible to use a fluorescence conversion dye that absorbs light in the ultraviolet region to convert the blue light. In order to prevent visibility of each color from lowering by incident external light, it is preferable to use a single fluorescence conversion dye having a large difference between an excitation wavelength and a fluorescence wavelength. For adjusting a wavelength and hue of outputted light, two or more fluorescence conversion dyes may be combined.

The fluorescence dyes that absorb the light with a wavelength in the blue or bluish-green region emitted from the light source to emit fluorescence with a wavelength in the red region include, for example, rhodamine-based colorants such as rhodamine B, rhodamine 6G, rhodamine 3B, rhodamine 101, rhodamine 110, sulforhodamine, basic violet 11, and basic red 3, cyanine-based colorants, pyridine-based colorants such as 1-ethyl-2-(4-(p-dimethylaminophenyl)-13-butadienyl)-pyridium-perchlorate (pyridine 1), and oxazine-based colorants. Furthermore, various dyes (direct dyes, acid dyes, basic dyes, disperse dyes, etc.) can be used provided that they are fluorescent. The rhodamine dyes preferably used in the invention may have the following general chemical structure.

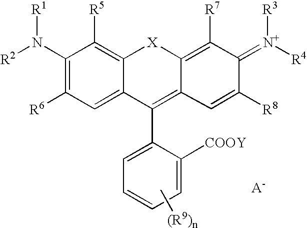

In the structure, each of R1 through R9 and Y is independently selected from the group consisting of H, an alkyl group of C1 through C30, a cycloalkyl group of C1 through C30, an alkenyl group of C1 through C30, an alkinyl group of C1 through C30, a haloalkyl group of C1 through C30, an alkoxylalkyl group of C1 through C30 and an arylalkyl group of C1 through C30. R1 and R5, R2 and R6, R3 and R7, or R4 and R8 can be combined to form a five- or six-membered ring. X represents O or S. A is selected from the group consisting of F, Br, I, ClO₄, BF₄, and ½(ZnCl₄), and n represents any one of integers of 0 through 4. When the dye is chemically bonded to the dendrimer, it is preferable that Y is H, or at least one of R1 through R9 is substituted by halogen, OH, NH₂, or COOH.

The fluorescent dyes that absorb the light with a wavelength in the blue region to the bluish green region emitted from the light source to emit fluorescence with a wavelength in the green region include, for example, coumarin dyes such as 3-(2′-benzothiazolyl)-7-diethylamino-coumarin (coumarin 6), 3-(2′-benzimidazolyl)-7-diethylamino-coumarin (coumarin 7), 3-(2′-N-methyl benzimidazolyl)-7-diethylamino-coumarin (coumarin 30) and 2,3,5,6-1H,4H-tetrahydro-8-trifluoromethylquinolidine (9,9a,1-gh) coumarin (coumarin 153), or basic yellow 51 as a dyestuff of a coumarin dye, and further naphthalimide dyes such as solvent yellow 11 and solvent yellow 116. Furthermore, various kinds of dyes (direct dyes, acid dyes, basic dyes and disperse dyes) can be also used as far as they are fluorescent. The coumarin dyes preferably used in the invention have the following general chemical structure.

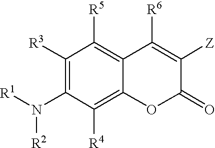

In the formula, each of R1 through R6 is independently selected from the group consisting of H, an alkyl group of C1 through C30, a cycloalkyl group of C1 through C30, an alkenyl group of C1 through C30, an alkinyl group of C1 through C30, a haloalkyl group of C1 through C30, an alkoxylalkyl group of C1 through C30 and ab arylalkyl group of C1 through C30. R1 and R3, R2 and R4, and/or R5 and R6 can be combined to form a five- or six-membered ring, and n represents any one of integers of 0 through 4. Z is selected from the group consisting of H, an alkyl group of C1 through C30, a cycloalkyl group of C1 through C30, an alkenyl group of C1 through C30, an alkinyl group of C1 through C30, a haloalkyl group of C1 through C30, an alkoxylalkyl group of C1 through C30, an arylalkyl group of C1 through C30, and a heterocycle having the following chemical structure.

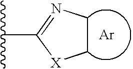

In the chemical structure, X represents O, NH or S. R7 is selected from the group consisting of H, an alkyl group of C1 through C30, a cycloalkyl group of C1 through C30, an alkenyl group of C1 through C30, an alkinyl group of C1 through C30, a haloalkyl group of C1 through C30, an alkoxylalkyl group of C1 through C30, and an arylalkyl group of C1 through C30. Ar is selected from the group consisting of a substituted or non-substituted benzene ring and a naphthalene ring. When the dye is chemically bonded to the dendrimer, it is preferable that at least one of R1 through R7 is substituted by halogen, OH, NH₂, or COOH.

The fluorescent dyes that absorb the light with a wavelength in the near ultraviolet region to the visible region emitted from the light source to emit fluorescence with a wavelength in the blue region include, for example, coumarin dyes such as coumarin 466, coumarin 47, coumarin 2, and coumarin 102. Furthermore, various kinds of dyes (direct dyes, acid dyes, basic dyes and disperse dyes) may be also used as far as they are fluorescent.

The dendrimer in the invention is a dendrite molecule formed of monomers forming Y-like branches and connected in order. According to the invention, the dendrimer used for the color conversion layer may have an arbitrary structure as far as the dendrimer is able to include the fluorescence conversion dye in a clathrate state or be chemically bonded to the fluorescence conversion dye to suppress an interaction among the fluorescence conversion dyes in the color conversion layer. It is preferable to use a dendrimer of the fourth to sixth generation, so that it is possible that the dendrimer includes the fluorescence conversion dye in a clathrate state to suppress the interaction among the fluorescence conversion dyes.

According to the invention, the fluorescence conversion dye may be chemically bonded to the dendrimer to form a fluorescence-conversion-dye-dendrimer bonded body. In this case, it is preferable that the fluorescence conversion dye is bonded to the dendrimer through a covalent bond. As an example of a fluorescence-conversion-dye-dendrimer bonded body, the fifth generation dendrimer and the rhordamine B are bonded through the covalent bond, as shown in the formula (1), in which R represents a methoxy group. The fifth generation dendrimer is formed of 1,1,1-tris(4-hydroxyphenyl) ethane as a core for forming the covalent bond to the rhodamine B and a dendrite section formed of 1,3-dihydroxybenzyl alcohol as a monomer.

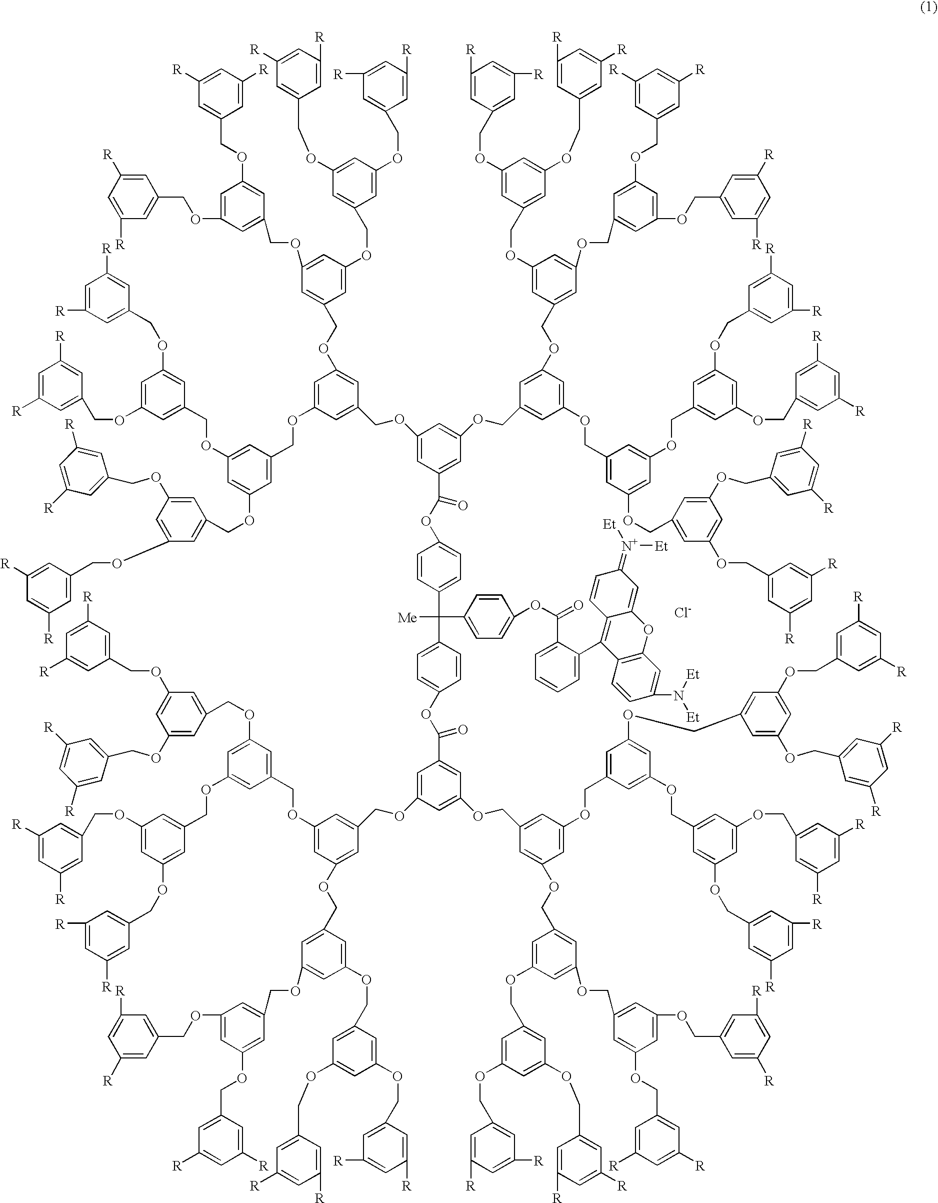

The fluorescence-conversion-dye-dendrimer bonded body may be formed with an arbitrary method known in the art. For example, a core component of the dendrimer is bonded to the fluorescence conversion dye, and then a separately synthesized dendrite section is bonded to the core. Alternatively, a core component of the dendrimer is bonded to the fluorescence conversion dye, and then a dendrite section is formed to extend from the core. When the fluorescence-conversion-dye-dendrimer bonded body is formed with such a method, it is particularly preferable to use a fluorescence conversion dye having a functional group such as alcohol, amine, carboxylic acid and ester at a site separated from a color development site of the dye and having no effect on the fluorescent characteristic of the dye. Moreover, when the fluorescence conversion dye with a plurality of the functional groups is used, the fluorescence conversion dye itself may be used as a core of the dendrimer.

According to the invention, the color conversion layer may include a fluorescence-conversion-dye-dendrimer clathrate body in a so-called clathrate state in which the fluorescence conversion dye is surrounded by a resinous section of the dendrimer molecule. The fluorescence-conversion-dye-dendrimer clathrate body is obtained by forming a solution including the fluorescence conversion dye and the dendrimer at a high concentration. As an example, rhodamine B may be included in the fifth generation dendrimer in a clathrate state, as shown in the following chemical structure (in the chemical structure, R represents a methoxy group). In the fifth generation dendrimer, a dendrite section formed of 1,3-dihydroxybenzyl alcohol as a monomer is bonded to bisphenol A as a core.

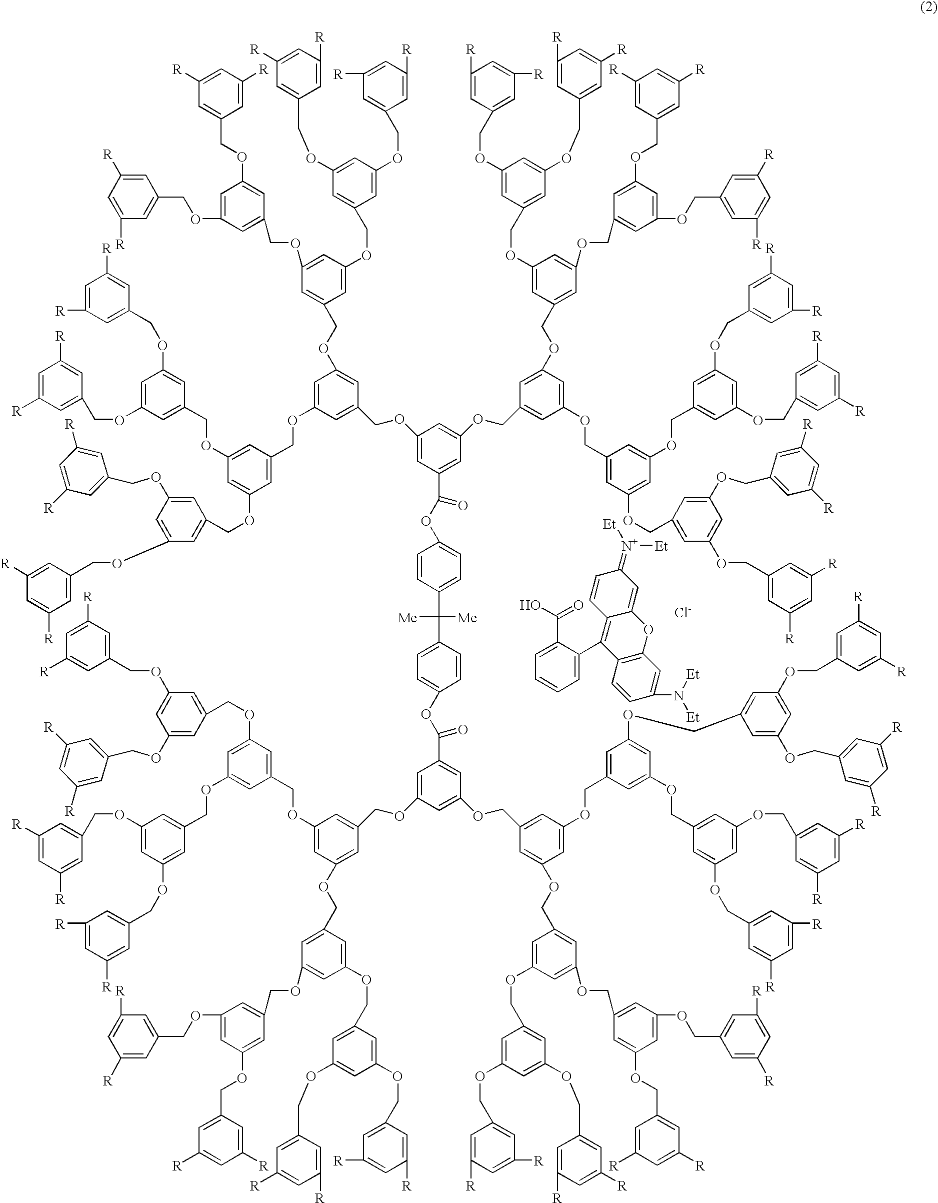

In the invention, it is preferable to use 2 or higher micromoles of the fluorescence conversion dye, preferably 6 to 20 micromoles, and more preferably, 10 to 14 micromoles per 1 g of a matrix resin. It is also preferable to use 1 mole of the dendrimer per 1 mole of the fluorescence conversion dye. When the fluorescence conversion dye is used at such a high concentration of more than 0.5 micromoles per 1 g of a matrix resin, if it were not for the dendrimer, the dye is rapidly degraded due to concentration quenching and decomposition. However, with the dendrimer, the dendrimer suppresses the interaction among the fluorescence conversion dyes, and obtains the high efficiency color conversion without causing the concentration quenching and decomposition.

It is reported that in porphyrin bonded to the dendrimer when the dendrite section of the dendrimer absorbs light, the absorbed energy is transferred to the porphyrin in the intramolecular singlet energy transfer, and the porphyrin emits fluorescence (KAGAKU TO KOGYO, 53 (2), 164(2000)). In the fluorescence-conversion-dye-dendrimer bonded body or clathrate body in the invention shown in the chemical structures (1) and (2), when the dendrite section is optimized, the effect can be obtained.

For example, in a case that a light source includes a wavelength around 365 nm near the ultraviolet region, when a dendrimer having an aromatic ring (preferably benzene ring) in the dendrite section is used, the dendrite section of the dendrimer absorbs the near ultraviolet light to excite the fluorescence conversion dye in a bonded state or clathrate state through the singlet energy transfer. In this case, it is possible to utilize light with a wavelength absorbed by the dendrite section of the dendrimer in addition to light with a wavelength absorbed by the fluorescence conversion dye, thereby increasing the color conversion efficiency.

In the invention, the matrix resin includes polyester methacrylate, polyvinyl chloride, a vinyl chloride-vinyl acetate copolymer resin, an alkyd resin, an aromatic sulfonamide resin, a urea resin, a melamine resin, a benzoguanamine resin, a mixture of these resins, and the like.

When it is necessary to form a pattern of the color conversion layer 20, a photo-setting resin or photo-thermo-setting resin (resist) may be used. In this case, the photo-setting resin or the photo-thermo-setting resin (resist) functions as the matrix resin. In order to form a pattern of the color conversion layer, it is desirable that the photo-setting resin or the photo-thermo-setting resin is soluble in an organic solvent or alkaline solution in an unexposed state.

The photo-setting resin or photo-thermo-setting resin includes (1) a composition containing an acrylic multifunctional monomer/oligomer having acroyl groups or methacroyl groups and a photo- or thermo-polymerization initiator, (2) a composition containing polyvinyl ester cinnamate and a sensitizer, (3) a composition containing a linear or cyclic olefin and bisazido, wherein nitrene is generated to cross-link the olefin, or (4) a composition containing monomers having an epoxy group and a photo oxidizer. In particular, the photo-setting resin or photo- and thermo-setting resin of (1) provides high resolution and easy pattern formation, as well as good solvent- and heat-resistance and the like.

It is preferred that the photo-polymerization initiator, sensitizer, and acid generator used in the present invention initiates the polymerization by light with a wavelength that the fluorescence conversion dye does not absorb. In the fluorescence conversion layer according to the present invention, when the photo-setting resin or photo-thermo-setting resin itself can be polymerized by light or heat, the photo- or thermo-polymerization initiator may be omitted.

According to the invention, a solution including the matrix resin, fluorescence conversion dye and dendrimer is prepared, and the solution is applied on the transparent substrate with a method known in the art such as spin coating, dip coating, roll coating or screen printing. The solution is then dried to form the color conversion layer 20. As described above, the fluorescence conversion dye may be chemically bonded to the dendrimer to form the fluorescence-conversion-dye-dendrimer bonded body. Alternatively, when preparing the solution, the fluorescence conversion dye and the dendrimer are mixed at a high concentration to thereby obtain the fluorescence-conversion-dye-dendrimer clathrate body.

Alternatively, a solution including the photo-setting resin or photo-thermo-setting resin, fluorescence conversion dye and dendrimer is prepared, and the solution is applied on the transparent substrate. The solution is subsequently exposed for patterning, so that the color conversion layer 20 is formed in a pattern. The patterning can be carried out with a commonly employed method in which an organic solvent or alkaline solution that solves or disperses the resin is used to remove the resin at the unexposed sections.

According to the invention, the color conversion layer 20 has a film thickness of 5 μm or larger, preferably 8 to 15 μm. With such a film thickness, it is possible to obtain the color-converted light with a desired intensity.

In the invention, a single kind of the color conversion layer 20 or a plurality of kinds of the color conversion layers 20 can be formed on the transparent substrate 10. When a plurality of kinds of the color conversion layers 20 are formed, a color conversion layer different from those in the other areas can be formed only at a certain area for performing so-called color conversion filtering for an area color display. Further, a set of the color conversion layers of red (R), green (G) and blue (B) is arranged on the transparent substrate 10 to form a color conversion filter for a display. Alternatively, a plural kinds of color conversion layers can be arranged in a pattern, sign, character, mark, and the like for displaying. Further, two kinds of the color conversion layers are divided into small regions and arranged with an appropriate area ratio for displaying a single color that can not be achieved by a single color conversion layer.

FIG. 2 is a view showing an example of a color conversion filter 110 for display according to the invention. The color conversion filter 110 is provided with color filter layers 30R, 30G and 30B for red (R), green (G) and blue (B), respectively, on the transparent substrate 10. Each of the color filter layers is provided for optimizing hue or color purity of light converted by each of color conversion layers. Red, green and blue color conversion layers 20R, 20G and 20B are provided on the respective color filter layers. Light from a light source passes through the color conversion layer 20, the color filter layer 30 and the transparent substrate 10 in the order to be emitted externally.

A black mask 40 may be provided in each of spaces between the respective colors for improving contrast. FIG. 2 shows a case in which the color conversion layers for each of the colors R, G and B are provided. When a light source emitting light ranging from blue to bluish green, no color conversion layer is used, and only a color filter layer is used for the blue color. Further, when the light emitted from the light source sufficiently includes the light in the green region, the light from the element is outputted through the green filter only.

A desired pattern of the color conversion layer and the color filter layer depends on an application. It is possible to form rectangular or circular zones of red, green and blue as a set on the whole surface of the transparent substrate. Alternatively, it is possible to form parallel stripes of red, green and blue (a zone having a desired width and a length equivalent to that of the transparent substrate 10) as a set on the whole surface of the transparent substrate. It is also possible to arrange specific color conversion layers larger (in the number and in an area) than those of the other color conversion layers.

According to the invention, a color conversion light emitting device has a light emitting section (a light source) and a color conversion section. For the color conversion section, the above-explained color conversion filter or the color conversion layer is used. For the light emitting section, an arbitrary light source emitting light ranging from the near ultraviolet region to the visible region, preferably from the blue to the bluish green region is used. Such a light source includes an EL light emitting element, a plasma light emitting element, a cold cathode tube, a discharge lamp (high voltage to ultra high voltage mercury lamp), a light emitting diode (LED), etc.

When the color conversion filter 100 shown in FIG. 1 is used for the color conversion section, the light emitting section can be provided on one of the color conversion layer 20 and the transparent substrate 10. When the color conversion filter 110 having the color filter layer 30 shown in FIG. 2 is used as the color conversion section, the light emitting section may be disposed on the side of the color conversion layer 20. Alternatively, when the color conversion layer itself is used as the color conversion section, the color conversion layer can be directly layered on a surface of the light source.

As an example of the color conversion light emitting device according to the invention, a top emission system organic EL display is formed of laminated color conversion filters, as shown in FIG. 3. TFTs 52 are formed on a substrate 50 as a switching element. Then, the organic EL element is formed on the substrate. The organic EL element includes a flattening layer 54, bottom electrodes 56, an organic light emitting layer 58, a top electrode 60, and a passivation layer 62. Each layer of the organic EL element may be formed of a material with a method known in the art. The blue, green and red color filter layers 30B, 30G and 30R, and the blue, green and red color conversion layers 20B, 20G and 20R each including the dendrimer are formed on the transparent substrate 10, respectively.

A black mask 40 is formed at spaces between the respective color conversion layers. Then, the organic EL element and the color conversion filter are positioned and bonded together while forming a filler layer 64 between them. Finally, a surrounding section is sealed with an outer part sealing layer (an adhesive) 66, thereby obtaining the organic EL display.

The organic light emitting layer 58 emits the light ranging from the near ultraviolet region to the visible region, preferably from the blue region to the bluish green region. The emitted light is incident on the color conversion filter layer to be converted to the visible light having a desired color. The organic light emitting layer 58 has a structure including at least an organic EL light emitting layer. A hole injection layer, a hole transport layer, and/or an electron injection layer may be included as necessary. Specifically, the following layer arrangements may be used.

(1) Organic EL light emitting layer

(2) Hole injection layer/Organic EL light emitting layer

(3) Organic EL light emitting layer/Electron injection layer

(4) Hole injection layer/Organic EL light emitting layer/Electron injection layer

(5) Hole injection layer/Hole transport layer/Organic EL light emitting layer/Electron injection layer

In the arrangements, a positive electrode is connected to the organic EL light emitting layer or the hole injection layer, and a negative electrode is connected to the organic EL light emitting layer or the electron injection layer.

A known material is used for each of the layers. For obtaining the light ranging from blue to bluish green, for example, fluorescent brighteners such as a benzothiazole type, a benzimidazole type and a benzoxazole type, a metalchelating oxonium compound, a styrylbenzene type compound, an aromatic dimethylidyne type compound, and the like are preferably used in the organic light EL light emitting layer.

### EXAMPLE 1

1.0 g of polymethyl methacrylate (PMMA) and 97 mg of the rhodamine B-dendrimer bonded body having the chemical structure (1) (containing 5.0 mg (10 micromoles) of rhodamine B) were solved in 1.0 g of a propylene glycol monoethyl acetate (PGEMA) solvent. The solution was applied on a Corning glass (50×50×1.0 mm) by the spin coating method. A color conversion filter having a color conversion layer with a film thickness of 10 μm was obtained.

### EXAMPLE 2

92 mg of the dendrimer section having the chemical structure (2) (10 micromoles) and 5.0 mg (10 micromoles) of rhodamine B were used instead of 97 mg of the rhodamine B-dendrimer bonded body used in the Example 1. The same process was repeated to obtain a color conversion filter.

### EXAMPLE 3

19 mg of the rhodamine B-dendrimer bonded body having the chemical structure (1) (containing 1.0 mg (2 micromoles) of rhodamine B) was used. The same process was repeated to obtain a color conversion filter.

### COMPARATIVE EXAMPLE 1

5.0 mg (10 micromoles) of rhodamine B was used instead of 97 mg of the rhodamine B-dendrimer bonded body used in the Example 1. The same process was repeated to obtain a color conversion filter.

### COMPARATIVE EXAMPLE 2

1.0 mg of rhodamine B (2 micromoles) was used instead of 97 mg of the rhodamine B-dendrimer bonded body used in the Example 1. The same process was repeated to obtain a color conversion filter.

### EVALUATION

Three samples were obtained from each of the Examples and Comparative Examples for the evaluation. A light source was disposed at a side of the color conversion layer of the color conversion filter, and light with a wavelength between 450 nm and 510 nm was irradiated. Then, light through the color conversion filter was measured for an intensity of the red component with a wavelength of 610 nm. A result of an initial intensity is summarized in Table 1 as a relative value in which the intensity of the red component in Example 1 is represented as 100.

Next, after the light source continuously irradiated the light for 1000 hours, an intensity of the red component with the wavelength of 610 nm was measured. A result of the relative intensity is summarized in Table 1 in which the intensity of the red component before the irradiation is represented as 100.

TABLE 1

| | Dye Content | | Intensity after |
|---|---|---|---|
| | (Micromole per | | 1000 hours |
| | 1.0 g of the | Initial | continuous |
| | matrix resin) | Intensity | irradiation |
| Example 1 | 5 | 100 | 90 |
| Example 2 | 5 | 95 | 84 |
| Comparative | 5 | 75 | 40 |
| Example 1 | | | |
| Example 3 | 2 | 90 | 84 |
| Comparative | 2 | 85 | 48 |
| Example 2 | | | |

In Table 1, Example 1, Example 2 and Comparative Example 1 provide a comparison of the color conversion filters containing a relatively high concentration of rhodamine B. Comparative Example 1 containing no dendrimer shows a low initial intensity. In contrast, Example 1 containing the fluorescence-conversion-dye-dendrimer bonded body and Example 2 containing the fluorescence-conversion-dye-dendrimer clathrate body show high color conversion efficiency despite the high concentration, indicating no concentration quenching.

Further, compared with Example 1 and Example 2, Comparative Example 1 shows poor durability. The result indicates that the dendrimer efficiently suppresses the interaction among the fluorescence conversion dyes at the high concentration condition, thereby preventing the decomposition of the dyes.

Example 3 and Comparative Example 2 provide a comparison of the color conversion filters containing a relatively low concentration of rhodamine B. Example 3 containing fluorescence-conversion-dye-dendrimer bonded body exhibits conversion efficiency at the initial stage approximately equivalent to that of Comparative Example 2 containing no dendrimer. Example 3 exhibits durability superior to that of Comparative Example 2. It is considered that the result is associated with the suppression of the interaction among the fluorescence conversion dyes by the dendrimer.

As described above, the fluorescence conversion dye is chemically bonded to the dendrimer or the fluorescence conversion dye included in the dendrimer is in the clathrate state. Therefore, it is possible to obtain the color conversion layer containing the fluorescence conversion dye at a high concentration without the reduction in the conversion efficiency due to the concentration quenching and the decomposition of the dye. The obtained color conversion layer has the superior conversion efficiency and durability.

While the invention has been explained with reference to the specific embodiments of the invention, the explanation is illustrative and the invention is limited only by the appended claims.

What is claimed is:

1. A color conversion layer for converting a wavelength distribution of light and emitting the converted light, comprising:
a matrix resin,
a fluorescence conversion dye, and
a dendrimer.

2. A color conversion layer according to claim 1, wherein said fluorescence conversion dye is bonded to the dendrimer through a covalent bond.

3. A color conversion layer according to claim 1, wherein said fluorescence conversion dye is included in the dendrimer in a clathrate state.

4. A color conversion filter comprising the color conversion layer according to claim 1, and a transparent substrate on which the color conversion layer is formed.

5. A color conversion light emitting device comprising a light emitting section, and the color conversion layer according Lo claim 1, said color conversion layer being disposed adjacent to the light emitting section for converting the wavelength distribution of light emitted from the light emitting section.

6. A color conversion layer according to claim 1, wherein said dendrimer includes a core portion and a branched portion having a plurality of monomers connected through branch portions.

7. A color conversion layer according to claim 6, wherein said core portion of the dendrimer is connected to the fluorescence conversion dye through a covalent bond.

8. A color conversion layer according to claim 1, wherein said dendrimer is at least one of a fourth generation dendrimer, a fifth generation dendrimer, and a six generation dendrimer.
